(19) United States
(12) Patent Application Publication
(10) Pub. No.: US 2026/0237281 A1
(43) Pub. Date: Aug. 13, 2026

(54) METHOD AND SYSTEM FOR PREDICTING FALL OF A USER

(71) Applicant: Tiara Grant, Rio Rancho, NM (US)

(72) Inventor: Tiara Grant, Rio Rancho, NM (US)

(21) Appl. No.: 19/050,211

(22) Filed: Feb. 11, 2025

(51) Int. Cl. G08B 21/04; G08B 5/22; G08B 21/18

(52) U.S. Cl. CPC G08B 21/043; G08B 5/222; G08B 21/0469; G08B 21/182

(57) ABSTRACT

The present disclosure discloses a method for predicting a fall of a user. The method includes detecting a static attribute, a dynamic attribute, and an activity associated with the user, based on a plurality of signals received using an electromagnetic sensor. The method includes determining a current static attribute score, a current dynamic attribute score, and current activity score. Further, the method includes determining a first comparison value based on a comparison between the current static attribute score and a predetermined static attribute score, a second comparison value based on a comparison between the current dynamic attribute score and a predetermined dynamic attribute score, and a third comparison value based on a comparison between the current activity score and a predetermined activity score. The method includes determining a fall score based on the first comparison value, the second comparison value, and the third comparison value.

### TECHNICAL FIELD

The present invention relates to fall prediction systems and methods, and more particularly, to a method and system for predicting falls by analyzing static and dynamic attributes, activity patterns, and physiological parameters of a user.

### BACKGROUND

With the global population ages rising, falls among the elderly pose a severe and growing public health concern. According to the U.S. Centers for Disease Control and Prevention (CDC), one in four Americans aged 65 or older experiences a fall each year. Every 11 seconds, an elderly individual is treated in emergency rooms for fall-related injuries, and a fall-related fatality occurs every 19 minutes. This makes falls the leading cause of injury-related deaths among the elderly. Moreover, falls are also the most common cause of nonfatal trauma-related hospital admissions in this demographic.

The susceptibility of the elderly to falls is attributed to several physiological and environmental factors. For example, declines in muscle strength, balance, and coordination due to age significantly increase the likelihood of falling. Further, the reduced ability to recover or brace oneself is often diminished, exacerbating the severity of the resulting injuries. Furthermore, the elderly frequently face longer recovery times, and even minor falls can lead to complications such as fractures, head injuries, or long-term disability. Moreover, a significant proportion of the elderly live alone, which can result in delays in receiving medical attention after a fall. In some cases, individuals who fall may remain undiscovered for hours or even days, thereby compounding the risk of severe health complications such as dehydration, hypothermia, or pressure sores. Such delays can also lead to increased emotional distress, diminished confidence in mobility, and a subsequent decline in overall quality of life.

The fall-related injuries can have significant economic implications. For instance. in 2015 alone, the total cost of fall-related injuries exceeded $50 billion, with Medicare and Medicaid shouldering approximately 75% of these expenses. This financial burden is expected to grow as the elderly population increases, further straining healthcare systems and emphasizing the need for effective fall prevention and management solutions.

Existing solutions for fall detection, while helpful, exhibit significant limitations. These solutions generally include emergency alert systems, such as wearable devices equipped with push-button mechanisms. However, these systems are inherently dependent on user interaction and accessibility. If the device is not worn, is removed, or if the individual is unconscious or otherwise unable to activate the alert, the system becomes ineffective. Moreover, these solutions are primarily reactive and focus on alerting caregivers or medical professionals after a fall has occurred, rather than addressing the underlying risk factors that lead to falls in the first place. Fall detection systems generally rely on post-event data or sensor inputs to identify a fall, without offering any proactive intervention to mitigate risks. For example, systems based on accelerometers or gyroscopes can detect abrupt movements indicative of a fall but do little to address pre-fall conditions such as instability or loss of balance. This reactive approach leaves a significant gap in addressing the broader challenges of fall prevention.

There is, therefore, a need for improved solutions that not only detect falls but also predict and prevent them. Secondly, these solutions should operate passively, without requiring constant user engagement, to ensure reliability even in situations where the user is incapacitated or unable to interact with the technology.

### SUMMARY

According to one embodiment, a method of predicting a fall of a user is disclosed. The method may include receiving, from an electromagnetic sensor, a plurality of signals associated with a user. The plurality of signals may be received over a predefined period of time. The method may further include detecting a static attribute and a dynamic attribute associated with the user, based on the plurality of signals. The static attribute may be associated with a static balance of the user, and the dynamic attribute may be associated with one of: a dynamic balance, or a gait of the user. The method may further include determining a current static attribute score indicative of a measure of the respective static attribute, and a current dynamic attribute score indicative of a measure of the respective dynamic attribute, based on the plurality of signals, and determining a first comparison value based on a comparison between the current static attribute score and a predetermined static attribute score. The method may further include determining a second comparison value based on a comparison between the current dynamic attribute score and a predetermined dynamic attribute score and determining a current activity score associated with an activity performed by the user based on the plurality of signals. The activity score may be indicative of at least one of: a time taken to perform the activity and a frequency of performing the activity. The method may further include determining a third comparison value based on a comparison between the current activity score and a predetermined activity score, and predicting a fall score associated with the user based on the first comparison value, the second comparison value, and the third comparison value. The fall score may be indicative of an anticipated fall of the user. Further, the method may include outputting the predicted fall score for displaying to a second user.

In some embodiments, the predetermined static attribute score may be one of: a threshold static attribute score and a historical static attribute score. The historical static attribute score may be associated with a plurality of historical signals received over a past predefined period of time. The predetermined dynamic attribute score may be one of: a threshold dynamic attribute score and a historical dynamic attribute score. The historical dynamic attribute score may be associated with the plurality of historical signals received over the past predefined period of time. Further, the predetermined activity score may be one of: a threshold activity score and a historical activity score. The historical activity score is associated with the plurality of historical signals associated with the activity.

In some embodiments, the activity associated with the user may include at least one of: bathroom or toilet visit, kitchen usage, medicine management, sleep, and movement within the premises.

In some embodiments, the method may further include assigning a first weightage to the first comparison value to calculate a weighted first comparison value, assigning a second weightage to the second comparison value to calculate a weighted second comparison value, and assigning a third weightage to the third comparison value to calculate a weighted third comparison value. The fall score associated with the user may be predicted based on the weighted first comparison value, the weighted second comparison value, and the weighted third comparison value.

In some embodiments, predicting the fall score may further include determining a current physiological feature score for a physiological feature associated with the user, based on the plurality of signals. The physiological feature associated with the user may be one of: a rate of respiration and a heart rate. Predicting the fall score may further include determining a fourth comparison value based on a comparison between the current physiological feature score and a predetermined physiological feature score, to determine a fourth comparison value. The fall score may be predicted based on the first comparison value, the second comparison value, the third comparison value, and the fourth comparison value.

In some embodiments, the predetermined physiological feature score may be a threshold physiological feature score. Alternatively, the predetermined physiological feature score may be a historical physiological feature score.

In some embodiments, the method may further include assigning a fourth weightage to the fourth comparison value to calculate a weighted fourth comparison value. The fall score associated with the user may be predicted based on the weighted first comparison value, the weighted second comparison value, the weighted third comparison value, and the weighted fourth comparison value.

In some embodiments, predicting the fall score may further include fetching, from a database, user profile data associated with the user. The user profile data may include at least one of: age, gender, and historical fall data associated with the user. Predicting the fall score may further include determining a user profile data score based on the user profile data, and predicting the fall score based on the first comparison value, the second comparison value, the third comparison value, and the user profile data score.

In some embodiments, the method may further include assigning a fifth weightage to the user profile data score to calculate a weighted user profile data score. The fall score associated with the user may be predicted based on the weighted first comparison value, the weighted second comparison value, the weighted third comparison value, and the weighted user profile data score.

In some embodiments, predicting the fall score may further include feeding the first comparison value, the second comparison value, and the third comparison value to a pre-trained Machine Learning (ML) model, and receiving, from the ML model, the fall score indicative of the anticipated fall of the user.

In some embodiments, the method may further include generating a notification based on the fall score for alerting the second user, when the fall score is above a threshold fall score.

In another embodiment, a system for predicting a fall of a user is disclosed. The system includes a processor, and a memory communicatively coupled to the processor. The memory stores a plurality of processor-executable instructions, such that the processor-executable instructions, upon execution by the processor, cause the processor to receive, from an electromagnetic sensor, a plurality of signals associated with a user. The plurality of signals may be received over a predefined period of time. The processor-executable instructions may further cause the processor to detect a static attribute, and a dynamic attribute associated with the user, based on the plurality of signals. The static attribute may be associated with a static balance of the user, and wherein the dynamic attribute is associated with one of: a dynamic balance, or a gait of the user. The processor-executable instructions may further cause the processor to determine a current static attribute score indicative of a measure of the respective static attribute, and a current dynamic attribute score indicative of a measure of the respective dynamic attribute, based on the plurality of signals, and determine a first comparison value based on a comparison between the current static attribute score and a predetermined static attribute score. The processor-executable instructions may further cause the processor to determine a second comparison value based on a comparison between the current dynamic attribute score and a predetermined dynamic attribute score, and determine a current activity score associated with an activity performed by the user based on the plurality of signals. The activity score may be indicative of at least one of: a time taken to perform the activity and a frequency of performing the activity. The processor-executable instructions may further cause the processor to determine a third comparison value based on a comparison between the current activity score and a predetermined activity score, and predict a fall score associated with the user based on the first comparison value, the second comparison value, and the third comparison value, wherein the fall score is indicative of an anticipated fall of the user. The processor-executable instructions may further cause the processor to output the predicted fall score for displaying to a second user.

In yet another embodiment, a non-transitory computer-readable medium storing computer-executable instructions for predicting a fall of a user is disclosed. The computer-executable instructions are configured for receiving, from an electromagnetic sensor, a plurality of signals associated with a user. The plurality of signals may be received over a predefined period of time. The computer-executable instructions may be configured for detecting a static attribute and a dynamic attribute associated with the user, based on the plurality of signals. The static attribute may be associated with a static balance of the user, and the dynamic attribute may be associated with one of: a dynamic balance, or a gait of the user. The computer-executable instructions may be configured for determining a current static attribute score indicative of a measure of the respective static attribute, and a current dynamic attribute score indicative of a measure of the respective dynamic attribute based on the plurality of signals, and determining a first comparison value based on a comparison between the current static attribute score and a predetermined static attribute score. The computer-executable instructions may be configured for determining a second comparison value based on a comparison between the current dynamic attribute score and a predetermined dynamic attribute score, and determining a current activity score associated with an activity performed by the user based on the plurality of signals. The activity score may be indicative of at least one of: a time taken to perform the activity and a frequency of performing the activity. The computer-executable instructions may be configured for determining a third comparison value based on a comparison between the current activity score and a predetermined activity score, and predicting a fall score associated with the user based on the first comparison value, the second comparison value, and the third comparison value. The fall score is indicative of an anticipated fall of the user. The computer-executable instructions may be configured for outputting the predicted fall score for displaying to a second user.

Still, other aspects, features, and advantages of the invention are readily apparent from the following detailed description, simply by illustrating a number of particular embodiments and implementations, including the best mode contemplated for conducting the invention. The invention is also capable of other and different embodiments, and its several details can be modified in various obvious respects, all without departing from the spirit and scope of the invention. Accordingly, the drawings and description are to be regarded as illustrative, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of an environment for predicting a fall of a user, according to an embodiment of the present disclosure.

FIG. 2 is a block diagram of one or more fall prediction features for predicting the fall of a user, in accordance with some embodiments.

FIG. 3 is a block diagram of the fall predicting device showing one or more modules, in accordance with some embodiments.

FIG. 4 is a schematic diagram of an environment for predicting a fall of a user, in accordance with some embodiments.

FIGS. 5-6 are schematic diagrams of processes of detecting physiological features associated with the user, in accordance with some embodiments.

FIGS. 7-9 are schematic diagrams of processes of detecting the features of gait and balance associated with the user are illustrated, in accordance with some embodiments.

FIG. 10 is another schematic representation of the premises and a process of monitoring various activities performed by a user within a premises, in accordance with some embodiments.

FIG. 11 is a graphical representation of weightages assigned to the various features associated with the user, in accordance with some embodiments.

FIG. 12 is a flowchart of a method of predicting a fall of a user, in accordance with some embodiments.

FIG. 13 is an exemplary computing system, in accordance with some embodiments.

### DETAILED DESCRIPTION

Examples of a system, method, and computer program for generating feature data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

The present disclosure relates to a method and system for detecting a fall of a user, and provides for addressing the increasing risk of falls among the elderly, which often result in severe or fatal injuries. The invention identifies deviations from activities of daily living without requiring the user to wear a device, and predicts potential falls to enable timely intervention.

The techniques of the present disclosure provide several advantages over existing fall detection solutions. For instance, the techniques eliminate the need for wearable devices such as necklaces or armbands for detection, ensuring continuous monitoring without user compliance issues. Further, the techniques assess the severity of falls and responds accordingly, enabling tailored interventions.

The system of the present disclosure achieves these goals by processing sensor(s) signals and deriving insights from physiological and kinematic data collected in the user's environment. By monitoring static and dynamic attributes, activities of daily living, and key physiological parameters, the invention predicts falls before they occur and facilitates faster intervention after a fall, significantly improving safety and reducing recovery time and associated costs. Additionally, the system leverages comparisons of real-time and historical data or threshold data of static balance, dynamic balance, gait, activity patterns, and physiological features such as respiration and heart rate. Profile data such as age, gender, and historical fall incidents are also incorporated, allowing for personalized fall prediction and risk assessment. Weighted scoring mechanisms further enhance the system's predictive accuracy, providing a comprehensive and proactive solution to fall detection and prevention.

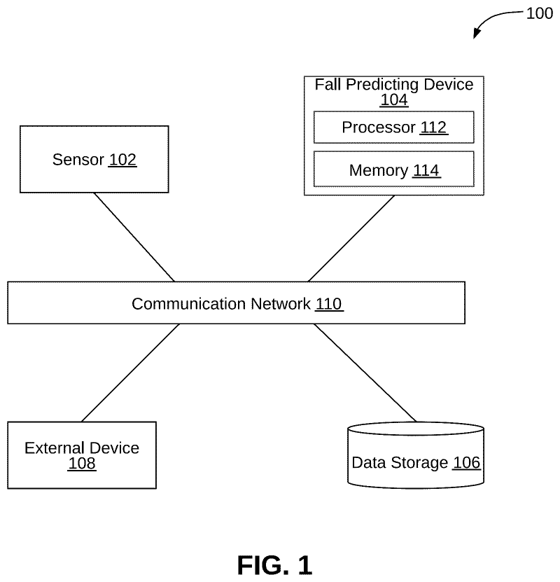

FIG. 1 illustrates an environment 100 for predicting a fall of a user, according to an embodiment of the present disclosure. The environment 100 may include an electromagnetic sensor 102 (also referred to as ‘sensor 102’) and a fall predicting device 104. The sensor 102 may be installed within a premises in which the user is located. For example, the premises may include a house, a care center, a hospital building, etc. In some embodiments, the sensor 102 may be a non-imaging sensor, such as an electromagnetic sensor.

In a preferred embodiment, the sensor 102 may be a Frequency Modulated Continuous Wave (FMCW) radar. As will be appreciated by those skilled in the art, FMCW sensor(s) are advanced radar sensor(s) that can be used for detecting and measuring motion, distance, and velocity of humans. FMCW sensor(s) continuously emit a frequency-modulated signal and measure the time delay and frequency shift of the reflected signal to calculate precise range and motion data. FMCW sensor(s) can be effective in applications involving human movement, such as sensing gait patterns and tracking mobility. The FMCW sensor(s) may operate by emitting electromagnetic waves that reflect off a person's body and analyzing the returned signal to detect motion dynamics. As such, the FMCW sensor(s) may be able to detect minute movements, such as limb oscillations or postural adjustments, enabling detailed gait analysis. By measuring Doppler shifts, FMCW sensor(s) may determine the speed and direction of movement, allowing for detailed tracking of gait dynamics. For performing gait sensing, the FMCW sensor(s) may analyze the reflected signals to map patterns of motion such as walking speed, stride length, and postural sway. It is worthwhile to note that the FMCW sensor(s) are capable of performing reliably in diverse environmental conditions, including low-light or obscured settings, where optical systems like cameras may fail. Moreover, the FMCW sensor(s) do not capture images or videos (unlike imaging sensor(s) like cameras), thereby preventing collection and storage of personal visual data, and enhancing privacy.

It should be noted that the sensor 102 may be installed in the premises in order to cover the entire expanse of the premises, so that the user can be monitored throughout the premises. As such, more the one sensor 102 may be installed within the premises for a comprehensive coverage of the premises. The sensor(s) 102 may, therefore, be configured to obtain a plurality of signals associated with the user located within a premises, predefined period of time. In other words, the sensor(s) 102 may be configured to transmit a plurality of signals and then receive the signals reflected from the surrounding objects and the user located within the premises. These reflected signals may contain information related to various parameters associated with the user.

The environment 100 may further implement a fall predicting device 104 that may be communicatively coupled with the sensor(s) 102 and configured to predict a fall of the user. The fall predicting device 104 may be a computing device having data processing capability. In particular, the fall predicting device 104 may have the capability of predicting a fall of the user located within the premises.

The environment 100 may further include a data storage 106. In some embodiments, the data storage 106 may store data associated with the user, and the signal data captured by the sensor(s) 102. The fall predicting device 104 may be communicatively coupled to an external device 108 for sending and receiving various data. Examples of the external device 108 may include, but are not limited to, a remote server, digital devices, and a computer system. A computing device, a smartphone, a mobile device, a laptop, a smart watch, a personal digital assistant (PDA), an e-reader, and a tablet are all examples of external devices 108.

The fall predicting device 104 may connect to the data storage 106 and the external device 108 over a communication network 110. For example, the communication network 110 may be a wireless network, a wired network, a cellular network, a Code Division Multiple Access (CDMA) network, a Global System for Mobile Communication (GSM) network, a Long-Term Evolution (LTE) network, a Universal Mobile Telecommunications System (UMTS) network, a Worldwide Interoperability for Microwave Access (WiMAX) network, a Dedicated Short-Range Communications (DSRC) network, a local area network, a wide area network, the Internet, satellite or any other appropriate network required for communication between the fall predicting device 104 and the data storage 104 and the external device 108.

The fall predicting device 104 may be configured to perform one or more functionalities that may include receiving, from an electromagnetic sensor, a plurality of signals associated with a user. The plurality of signals may be received over a predefined period of time. The one or more functionalities may further include detecting a static attribute and a dynamic attribute associated with the user, based on the plurality of signals. The static attribute may be associated with a static balance of the user, and the dynamic attribute may be associated with one of: a dynamic balance, or a gait of the user. The one or more functionalities may further include determining a current static attribute score indicative of a measure of the respective static attribute, and a current dynamic attribute score indicative of a measure of the respective dynamic attribute, based on the plurality of signals, and determining a first comparison value based on a comparison between the current static attribute score and a predetermined static attribute score. The one or more functionalities may further include determining a second comparison value based on a comparison between the current dynamic attribute score and a predetermined dynamic attribute score, and determining a current activity score associated with an activity performed by the user based on the plurality of signals. The activity score may be indicative of at least one of: a time taken to perform the activity and a frequency of performing the activity. The one or more functionalities may further include determining a third comparison value based on a comparison between the current activity score and a predetermined activity score, and predicting a fall score associated with the user based on the first comparison value, the second comparison value, and the third comparison value. The fall score may be indicative of an anticipated fall of the user. Further, the one or more functionalities may include outputting the predicted fall score for displaying to a second user.

To perform the above functionalities, the fall predicting device 104 may include a processor 112 and a memory 114. The memory 114 may be communicatively coupled to the processor 112. The memory 114 stores a plurality of instructions, which upon execution by the processor 112, cause the processor 112 to perform the above functionalities. Additionally, the fall predicting device 104 may implement a user interface that may further implement a display. Examples may include, but are not limited to a display, keypad, microphone, audio speakers, vibrating motor, LED lights, etc. The user interface may receive input from a user and also display an output of the computation performed by the fall predicting device 104.

In an embodiment, the fall predicting device 104 may be implemented over a remote server that may be implemented, for example, on a cloud network. To this end, in some embodiments, the sensor 102 may be equipped or connected with a transmission module for transmitting signals to the fall predicting device 104 over the communication network 110.

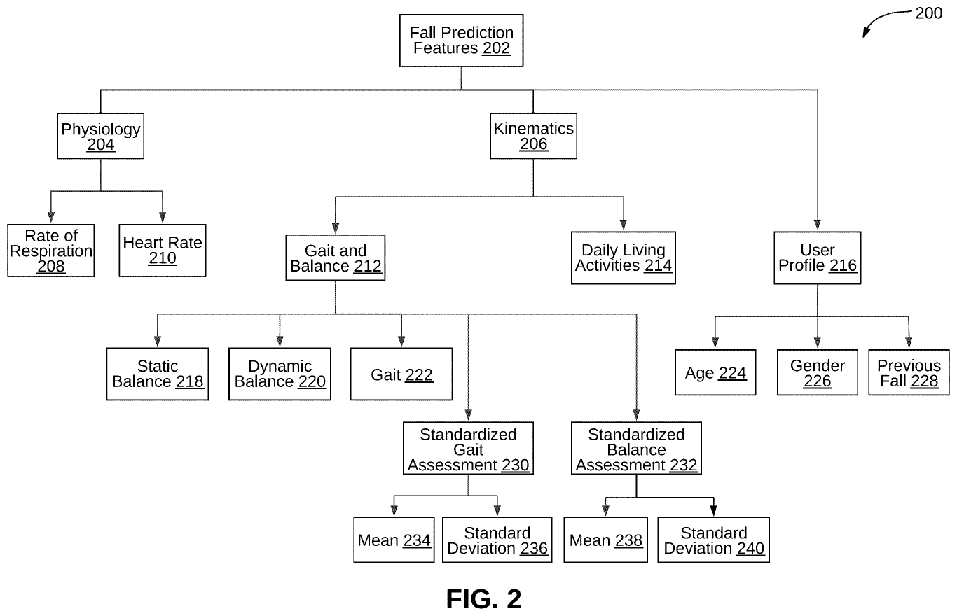

As mentioned above, the fall predicting device 104 may be configured to detect a static attribute and a dynamic attribute, and further monitor an activity associated with the user. As mentioned above, the static attribute may be associated with a static balance of the user, and the dynamic attribute may be associated with one of: a dynamic balance, or a gait of the user. The activity associated with the user may include a bathroom or a toilet visit, kitchen usage, medicine management, sleep, and movement within the premises. Additionally, the fall predicting device 104 may be configured to determine a physiological feature score for a physiological feature associated with the user corresponding to each of the plurality of signals. For example, the physiological features associated with the user may include a rate of respiration or a heart rate. Moreover, the fall predicting device 104 may fetch, from a database (e.g. the data storage 106), user profile data associated with the user. As such, the fall predicting device 104 may take into account some or all of the above features to predict the fall of the user. These features are further explained in detail, in conjunction with FIG. 2.

Referring now to FIG. 2, a block diagram 200 of the one or more fall prediction features 202 for predicting the fall of a user is illustrated, in accordance with some embodiments. The fall prediction features 202 may be classified into three categories of physiology 204, kinematics 206, and user profile data 216.

The features related to physiology 204 may include a rate of respiration 208 and a heart rate 210. The rate of respiration 208 and the heart rate 210 may be obtained using the sensor 102 or using a secondary sensor worn by the user. For example, this secondary sensor may be implemented in a wearable device, such as a smart watch or a smart band worn by the user.

The features related to kinematics 206 may include features related to a gait and balance sub-category 212, and a daily living activities sub-category 214 (also, simply referred to as activities sub-category 214). The gait and balance sub-category 212 may include features of a static balance 218, dynamic balance 220, and a gait 222. As will be understood, balance is the ability to maintain stability and control the body position while standing, walking, or performing movements, relying on sensory input and motor function. Static balance 218 is the ability to maintain a stable posture and equilibrium while the body is stationary, such as standing still. Dynamic balance 220 is the capacity to maintain stability and control while the body is in motion, such as walking or changing positions. As will be further understood, gait 222 may refer to the manner or pattern of walking, involving coordinated movement of the legs, arms, and torso.

Each of the static balance 218, the dynamic balance 220, and the gait 222 may be detected based on the signals obtained by the sensor 102. The sensor 102 (i.e. the FMCW radar sensor) may detect subtle sway or shifts in the body while a person is stationary. By measuring minute movements of the torso or limbs (postural sway), the sensor 102 may capture deviations in equilibrium over time, such that low Doppler shifts may indicate minimal movement consistent with static balance 218. In order to detect dynamic balance 220, the sensor 102 may measure motion patterns, velocity, and acceleration during activities such as walking or turning. By continuously tracking body movement trajectories, the sensor 102 may identify coordinated motions indicative of stable dynamic balance, such that Doppler frequency variations allow detection of speed and direction of movement. The gait 222 may be inferred by the sensor 102 from angular changes in body orientation relative to a reference position. To this end, the sensor 102 may detect displacement patterns and changes in the range profiles of body segments, calculating angular deviations, to thereby correlate to a tilting motion. It should be noted that the static balance 218 is a static physiological feature, as it is measured at rest. The dynamic balance 220 and the gait 222 are dynamic physiological features, since these features are related to changes or activities over time, like walking, running, or other movement patterns.

Features related to the gait and balance sub-category 212 may further include a standardized gait assessment 230 and a standardized balance assessment 232. The standardized gait assessment 230 and a standardized balance assessment 232 may be determined based on sets of signals obtained by the sensor 102, over a predefined period of time. Further, the standardized gait assessment 230 may include a mean gait 234 and a standard deviation 236 associated with the gait of the user. The standardized balance assessment 232 may include a mean balance 238 and a standard deviation 240 associated with the balance of the user. For example, the standardized gait assessment 230 and the standardized balance assessment 232 may be indicative of patterns of the user's gait and balance, respectively, over a period of time. A comparison of the current gait and balance with respect to the standardized gait assessment 230 and the standardized balance assessment 232 may provide an indication of a recent change in the gait or balance of the user, which could be possible assist in predicting a fall of the user in the near future.

The user profile data 216 may include features of age 224, gender 226, and previous fall data 228 associated with the user. Data related to the features of age 224, gender 226, and previous fall data 228 may be fed to the fall predicting device 104 at the time of the user registering with the fall predicting device 104. Further, the previous fall data 228 may be updated from time to time.

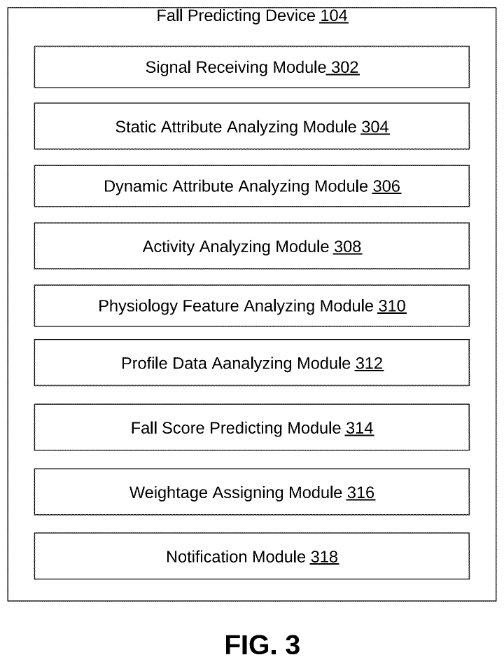

Referring now to FIG. 3, a block diagram of the fall predicting device 104 showing one or more modules is illustrated, in accordance with some embodiments. In some embodiments, the fall predicting device 104 may implement a signal receiving module 302, a static attribute analyzing module 304, a dynamic attribute analyzing module 306, an activity analyzing module 308, a physiological feature analyzing module 310, a user profile data analyzing module 312, a fall score predicting module 314, a weightage assigning module 316, and a notification module 318.

The signal receiving module 302 may be configured to receive a plurality of signals associated with a user located within a premises, from the sensor 102. For example, the plurality of signals may be received by the signal receiving module 302 from the electromagnetic sensor 102 over a predefined period of time. As mentioned above, the electromagnetic sensor 102 may be an FMCW radar sensor that may be installed in the premises. As further mentioned above, multiple electromagnetic sensor(s) 102 may be installed within the premises to cover the entire expanse of the premises.

The static attribute analyzing module 304 may be configured to detect a static attribute associated with the user corresponding to each of the plurality of signals, based on each of the plurality of signals. Further, the static attribute analyzing module 304 may be configured to determine a static attribute score corresponding to the detected attribute. As mentioned in association with FIG. 2, the static attribute may include a static balance associated with the user. As further mentioned above, the sensor 102 may detect subtle sway or shifts in the body while a person is stationary. By measuring minute movements of the torso or limbs (postural sway), the sensor 102 may capture deviations in equilibrium over time, such that low Doppler shifts may indicate minimal movement consistent with static balance 218. The static attribute score may be determined based on a level of static balance detected corresponding to the signals obtained. The static attribute score may be therefore indicative of how much static balance the user is having at a given time. For example, a higher score may be indicative of a higher degree of balance.

The static attribute analyzing module 304 may be further configured to perform a first comparison between a current static attribute score and a predetermined static attribute score, to determine a first comparison value based on the comparison between the current static attribute score and the predetermined static attribute score. It should be noted that the predetermined static attribute score may be a threshold static attribute score or a historical static attribute score. The historical static attribute score may be associated with a plurality of historical signals received over a past predefined period of time. In other words, the threshold static attribute score may be a fixed, predefined value set as a benchmark or cutoff, and may represent a minimum or maximum value that an attribute needs to meet or exceed to satisfy specific criteria. The historical static attribute score may be derived from data collected over time, specifically from a plurality of historical signals or inputs received during a past predefined period. These historical signals or input signals may include various measurements, events, or other relevant data points that collectively contribute to determining the historical static attribute score. The historical static attribute score, therefore, may reflect trends, patterns, or averages over a defined period.

The static attribute score is continuously recorded and stored in the database. The static attribute analyzing module 304 may dynamically compare the current static attribute score with the predetermined static attribute score (stored in the database), to thereby identify a change in the static attribute score. A sudden or gradual drop in the score may be therefore indicative of a possibility of a fall of the user occurring in the near future.

The dynamic attribute analyzing module 306 may be configured to detect a dynamic attribute associated with the user corresponding to each of the plurality of signals, based on each of the plurality of signals. Further, the dynamic attribute analyzing module 304 may be configured to determine a dynamic attribute score for the detected attribute. As mentioned in association with FIG. 2, the dynamic attribute may include a dynamic balance, and a gait associated with the user. The dynamic balance 220 may be detected based on motion patterns, velocity, and acceleration during activities such as walking or turning. By continuously tracking body movement trajectories, the sensor 102 may identify coordinated motions indicative of stable dynamic balance, such that Doppler frequency variations allow detection of speed and direction of movement. The gait 222 may be inferred by the sensor 102 from angular changes in body orientation relative to a reference position. As such, the sensor 102 may detect displacement patterns and changes in the range profiles of body segments, calculating angular deviations, to thereby correlate to a tilting motion. The dynamic attribute score may be determined based on a level of dynamic balance and a level of normalcy in the gait detected corresponding to the signals obtained. The dynamic attribute score may therefore indicate the user's level of dynamic balance and the normality of their gait at a given time. For example, a higher score may be indicative of a higher level of balance and a normal gait.

The dynamic attribute analyzing module 306 may be further configured to perform a second comparison between a current dynamic attribute score and a predetermined dynamic attribute score, to determine a second comparison value. The predetermined dynamic attribute score may be a threshold dynamic attribute score or a historical dynamic attribute score. The historical dynamic attribute score may be associated with the plurality of historical signals received over the past predefined period of time. The threshold dynamic attribute score may be a predefined or fixed benchmark value set for assessing dynamic attributes, and may serve as a reference point or cutoff that dynamic conditions or metrics are compared against. The historical dynamic attribute score may be calculated based on a collection of historical signals or data points received over a predefined past period. These historical signals or data points may represent measurements, events, or other relevant inputs gathered over time. The historical dynamic attribute score may reflect patterns, averages, or trends from these data points, offering insights into how the dynamic attribute has behaved over a specific time window.

The dynamic attribute score may be continuously recorded and stored in the database. The dynamic attribute analyzing module 304 may dynamically compare the current dynamic attribute score with the predetermined dynamic attribute score, to thereby identify a change in the dynamic attribute score. A sudden or gradual drop in the score may be indicative of a possibility of a fall of the user occurring in the near future.

The activity analyzing module 308 may be configured to monitor an activity associated with the user, based on the plurality of signals. For example, the activity associated with the user may include a bathroom or toilet visit, a kitchen usage, a medicine management, sleep, or movement within the premises. In particular, with respect to the bathroom or toilet visit, the activity analyzing module 308 may monitor how much time the user is spending in the bathroom or the toilet or how frequently the user is using the bathroom or the toilet. Further, with respect to the kitchen usage, the activity analyzing module 308 may monitor how much time the user is spending in the kitchen, or how frequently the user is accessing the appliances (e.g. the refrigerator, stovetop, dishwasher, etc.) in the kitchen. With respect to the medicine management, the activity analyzing module 308 may monitor how regularly the user is taking or replenishing their medicines. With respect to sleep, the activity analyzing module 308 may monitor for how long the user is sleeping, the timings of going to sleep and waking up, etc. With respect to movement within the premises, the activity analyzing module 308 may monitor how much the user is moving within the premises, or monitor the speed of movement of the user.

The activity analyzing module 308 may be further configured to determine an activity score associated with the activity, based on the plurality of signals. The activity score may be determined based on a level of normalcy of performing the activity by the user, corresponding to the signals obtained. In particular, for example, when the time spent or the frequency of using the bathroom or toilet by the user is within predefined limits, a higher activity score may be ascertained. Similarly, when the time spent in the kitchen or the frequency of accessing the appliances in the kitchen is within predefined limits, a higher activity score may be ascertained. In the same way, when the user is taking or replenishing their medicines regularly, the length and timing of sleep, and the movement within the premises are within predefined limits, a higher activity score may be ascertained.

The activity analyzing module 308 may be further configured to perform a third comparison between a current activity score and a predetermined activity score, thereby determining a third comparison value. For example, the predetermined activity score may be a threshold activity score or a historical activity score. The historical activity score may be associated with the plurality of historical signals associated with the activity. The historical activity score may be determined corresponding to a plurality of signals obtained over a past predefined period of time. In other words, the activity score is continuously recorded and stored in the database. The activity analyzing module 308 may dynamically compare the current activity score with the historical activity scores stored in the database, to thereby identify a change in the activity score. A sudden or gradual drop in the score may be indicative of a possibility of a fall of the user occurring in the near future.

In some embodiments, the weightage assigning module 316 may assign a weightage to each of the first comparison value, the second comparison value, and the third comparison value. In particular, the weightage assigning module 316 may assign a first weightage to the first comparison value to calculate a weighted first comparison value, a second weightage value to the second comparison value to calculate a weighted second comparison value, and a third weightage value to the third comparison value to calculate a weighted third comparison value. For example, the first comparison value and the second comparison value may be assigned a combined weightage of 45%. In other words, a combination of the first weightage and the second weightage may be 45%. The third comparison value may be assigned the third weightage of 25%.

As such, in such embodiments, the fall score associated with the user may be predicted based on the weighted first comparison value, the weighted second comparison value, and the weighted third comparison value. Specifically, the fall score predicting module 314 may aggregate data from these comparisons, which could involve assessing parameters such as gait and balance against thresholds or historical data. The fall prediction score may serve as an indicator of an individual's likelihood of experiencing a fall. For instance, the first comparison value may indicate discrepancies in step length or speed, the second comparison value may indicate deviations in body sway, and the third comparison value may indicate variations in limb coordination or posture stability. By synthesizing these comparison values, a comprehensive fall score is determined that reflects the individual's overall risk level. This fall score may then be used to trigger alerts, recommend preventive actions, or provide real-time feedback to minimize the risk of falls.

In some embodiments, the physiological feature analyzing module 310 may obtain physiological feature data associated with the user. As mentioned above, the physiological feature data may include a rate of respiration and a heart rate. The rate of respiration and the heart rate may be obtained using the sensor 102, or a secondary sensor worn by the user. For example, this secondary sensor may be implemented in a wearable device, such as a smart watch or a smart band worn by the user. The physiological feature analyzing module 310 may be further configured to determine a physiological feature score for a physiological feature associated with the user corresponding to the plurality of signals. As such, depending on the detected rate of respiration and heart rate, the corresponding physiological feature score may be ascertained. Further, the physiological feature analyzing module 310 may perform a fourth comparison between a current physiological feature score and a predetermined physiological feature score, to determine a fourth comparison value. The predetermined physiological feature score may be either a threshold physiological feature score or a historical physiological feature score. In this embodiment, the fall score predicting module 314 may predict the fall score based on the first comparison value, the second comparison value, the third comparison value, and the fourth comparison value.

In some embodiments, the weightage assigning module 316 may assign a fourth weightage to the fourth comparison value to calculate a weighted fourth comparison value. For example, the fourth comparison value may be assigned the fourth weightage of 10%. Therefore, in such embodiments, the fall score associated with the user may be predicted based on the weighted first comparison value, the weighted second comparison value, the weighted third comparison value, and the weighted fourth comparison value.

Further, in some embodiments, the user profile data analyzing module 312 may be configured to fetch, from the database, user profile data associated with the user. As mentioned above, the user profile data associated with the user may include age, gender, and previous fall data associated with the user. Data related to the features of age, gender, and previous fall data may be fed to the fall predicting device 104 at the time of the user registering with the fall predicting device 104, and the previous fall data 228 may be updated from time to time. The user profile data analyzing module 312 may be further configured to determine a user profile data score, based on the user profile data. In this embodiment, the fall score predicting module 314 may predict the fall score based on the first comparison value, the second comparison value, the third comparison value, and the user profile data score. Specifically, the fall score predicting module 314 combines dynamic and static physiological parameters derived from the comparisons, such as gait and balance, with personalized information captured in the user profile data score. By synthesizing these inputs, the fall score predicting module 314 generates a final fall score, which reflects the individual's current and long-term fall risk. This fall score may then be used to recommend preventive interventions, such as physiotherapy, assistive devices, or behavioral changes, tailored to the individual's unique profile and risk factors.

In some embodiments, the weightage assigning module 316 may assign a fifth weightage to the user profile data score to calculate a weighted user profile data score. For example, the user profile data score may be assigned the fifth weightage of 20%. Therefore, in such embodiments, the fall score associated with the user may be predicted based on the weighted first comparison value, the weighted second comparison value, the weighted third comparison value, and the weighted user profile data score.

The notification module 318 may be configured to generate a notification based on the predicted fall score. For example, when the predicted fall score is above a threshold thereby indicating a higher probability of a fall occurring in the near future, the notification may generate the notification that may be presented on a computing device, such as a smartphone or personal computer. The notification may alert a caregiver to intervene to take actions, such as physiotherapy, assistive devices, or behavioral changes, tailored to the user's unique profile and risk factors.

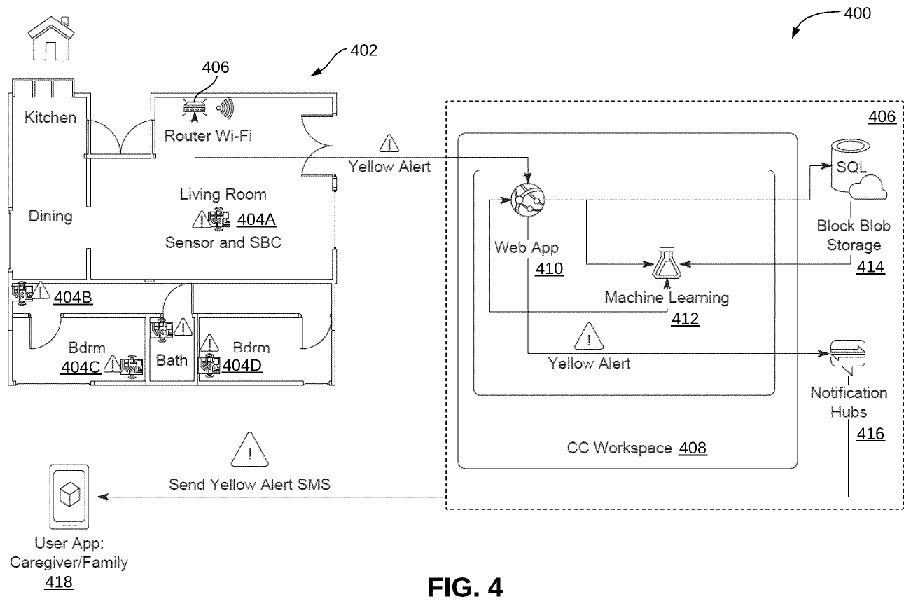

Referring now to FIG. 4, a schematic drawing of an environment 400 (corresponding to the environment 100) of predicting a fall of a user is illustrated, in accordance with some embodiments.

As shown in FIG. 4, the environment 400 includes a plurality of sensor(s) 404A, 404B, 404C, 404D (hereinafter, also collectively referred to as sensor(s) 404) installed within a premises 402. The premises 402, for example, may be a residential building, such that the sensor 404A is installed in a living room, the sensor 404B is installed in an alley, the sensor 404C is installed in a first bedroom, and the sensor 404D is installed in a second bedroom. Therefore, the sensor(s) 404 collectively may cover the entire the premises 402, and are able to monitor the user who may be present at any part of the premises 402.

As mentioned above, in some embodiments, the sensor(s) 404 may be electromagnetic sensor(s), such as FMCW radar sensor(s). The sensor(s) 404 may, therefore, be configured to obtain a plurality of signals associated with the user located within the premises 402, over a predefined period of time. In other words, the sensor(s) 404 may be configured to transmit a plurality of signals and then receive the signals reflected from the surrounding objects and the user located within the premises. These reflected signals may contain information related to various parameters associated with the user.

The environment 400 may further implement a fall predicting platform 406 (corresponding to the fall predicting device 104) that may be communicatively coupled to the sensor 404 and configured to predict the fall of the user. The fall predicting platform 406 may include a computing device having data processing capability. The fall predicting platform 406 may implement a workspace 408 that further implements a web application 410. The web application 410 may perform the various steps for predicting the fall score, based on the first comparison value, the second comparison value, and the third comparison value, as well as the fourth comparison value and the fifth comparison value. For example, the web application 410 may include a rule engine for performing the above prediction of the fall score. In some embodiments, additionally, the workspace 408 may further implement a machine learning (ML) model 412 that may be trained for predicting the fall of the user, based on the static attribute, the dynamic attribute, the activity, along with the physiological feature, and the user profile data.

The fall predicting platform 406 may include a storage 414 that may store data associated with the user and the signal data captured by the sensor 404.

Further, the fall predicting platform 406 may include a notification hub 416 which implements the notification module 318. The notification hub 416 may generate a notification based on the predicted fall score. For example, when the predicted fall score is above a threshold thereby indicating a higher probability of a fall occurring in the near future, the notification may generate the notification that may be presented on a computing device, such as a smartphone 418 via a user application (app). This notification may alert a caregiver to intervene to take actions, such as physiotherapy, assistive devices, or behavioral changes, tailored to the user's unique profile and risk factors.

The fall predicting platform 406 may receive, from the sensor(s) 404, a plurality of signals associated with a user located within the premises 402, the plurality of signals being obtained over a predefined period of time.

The fall predicting platform 406 may further detect a static attribute and a dynamic attribute associated with the user. The fall predicting platform 406 may further determine a static attribute score associated with the static attribute and a dynamic attribute score associated with the dynamic attribute, based on the plurality of signals. Further, the fall predicting platform 406 may perform a first comparison between a current static attribute score and a predetermined static attribute score, to determine a first comparison value. The fall predicting platform 406 may perform a second comparison between a current dynamic attribute score and a predetermined dynamic attribute score, to determine a second comparison value. The predetermined static attribute score may be either a threshold static attribute score or a historical static attribute score. Similarly, a predetermined dynamic attribute score may be either a threshold dynamic attribute score or a historical dynamic attribute score. The historical static attribute score and the historical dynamic attribute score may be determined corresponding to a plurality of signals obtained over a past predefined period of time. The fall predicting platform 406 may further monitor an activity associated with the user, and determine an activity score associated with the activity, based on the plurality of signals. The fall predicting platform 406 may then perform a third comparison between a current activity score and a predetermined activity score, to determine a third comparison value. The predetermined activity score may be a threshold activity score or a historical activity score, such that the historical activity score is determined corresponding to a plurality of signals obtained over a past predefined period of time. The fall predicting platform 406 may further predict the fall score indicative of a possibility of an anticipated fall of the user, based on the first comparison value, the second comparison value, and the third comparison value.

In an embodiment, the fall predicting platform 406 may be implemented over a remote server that may be implemented, for example, on a cloud network. As such, in such embodiments, the sensor(s) 404 may be equipped or connected with a transmission module for transmitting signals to the fall predicting platform 406 over a communication network.

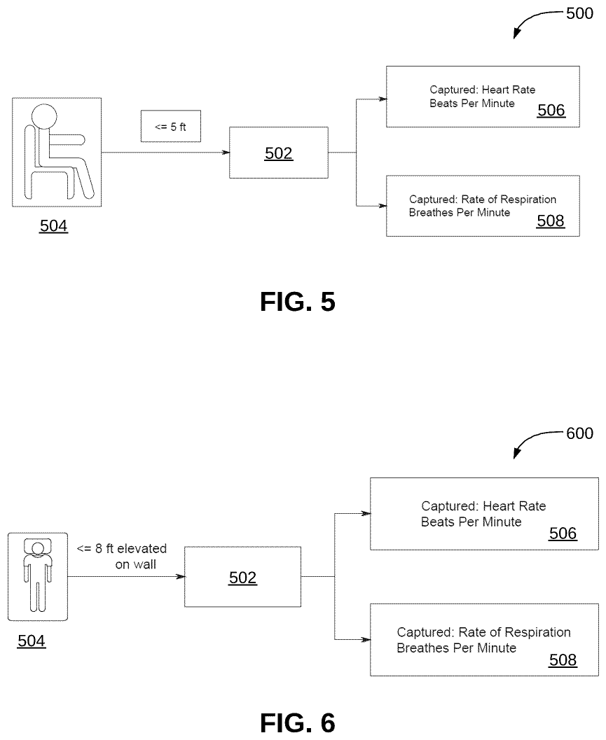

Referring now to FIGS. 5-6, schematic drawings of processes of detecting the physiological features associated with the user are illustrated, in accordance with some embodiments. In particular, as shown in FIG. 5, a sensor 502 may be used for determining a physiological feature score for physiological feature(s) associated with the user corresponding to the plurality of signals captured by the sensor 502. As mentioned above, the physiological features may be a rate of respiration and a heart rate. The rate of respiration and the heart rate may be obtained using the FMCW radar sensor 102, 404, or using a secondary sensor worn by the user. For example, this secondary sensor may be implemented in a wearable device, such as a smart watch or a smart band worn by the user.

FIG. 5 shows an environment 500 in which the sensor 502 is the FMCW radar sensor that may be positioned less than 5 feet away from a user 504, when the user 504 is in a sitting position. The sensor 502 may therefore obtain signals containing information related to a heat rate 506 and a rate of respiration 508 of the user. The sensor 502 may be communicatively coupled with the fall predicting device 104 (or the fall predicting platform 406) and may transmit these signals to it via a communication network. For example, the communication network may be a Wi-Fi network. To this end, the sensor 502 may be equipped with or connected to a Wi-Fi module, so as to transmit the signals to the fall predicting device 104 over the Wi-Fi network. Once the signals are received from the sensor 502, the fall predicting device 104 (or the fall predicting platform 406) may capture the heat rate 506 and a rate of respiration 508 of the user.

As shown in FIG. 6, in an environment 600, the sensor 502 (FMCW radar sensor) may be positioned farther away but less than 8 feet away from the user 504, when the user 504 is in a lying position (e.g. sleeping). Again, the sensor 502 may obtain signals containing information related to the heat rate and rate of respiration of the user, and may transmit the signals to the fall predicting device 104 over the Wi-Fi network.

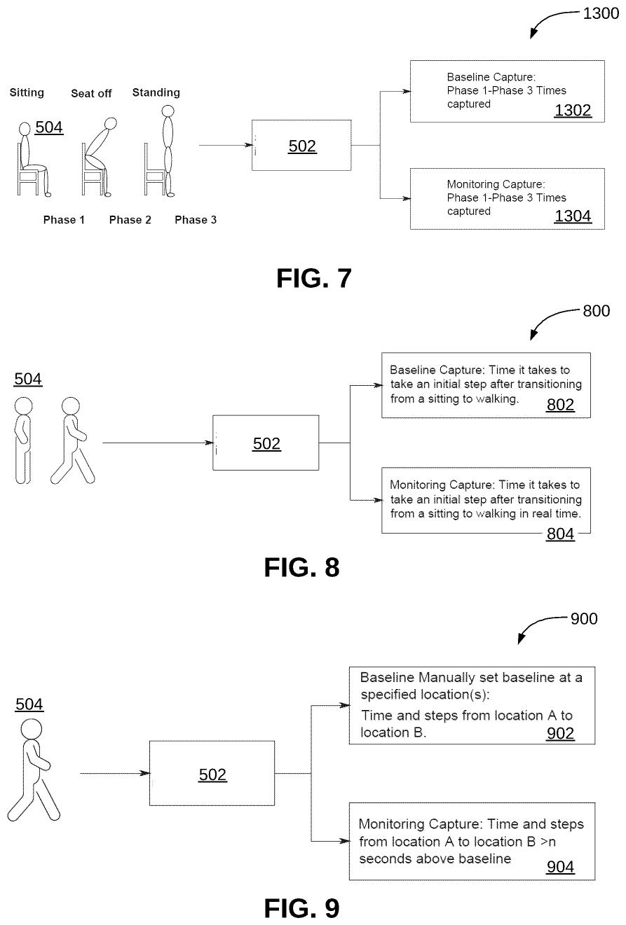

Referring now to FIGS. 7-9, schematic drawings of processes of detecting the features of gait and balance associated with the user are illustrated, in accordance with some embodiments. As shown in FIG. 7, the sensor 502 may be used for determining the features of gait and balance, corresponding to the plurality of signals captured by the sensor 502. In an environment 700, as shown in FIG. 700, a sitting-to-standing movement of the user 504 may be captured using the sensor 502, i.e. the FMCW radar sensor, that may be located away from the user 504, and may capture the signals corresponding to different phases of the movement of the user 504. In particular, a first phase (phase-1) at a first point in time may be captured, at which the user is still in a sitting position. Thereafter, a second phase (phase-2) may be captured at a second point in time, at which the user is in a seated off position, i.e. in an intermediate position between fully seated and fully standing position. Further, a third phase (phase-3) may be captured at a third point in time, at which the user is in a (fully) standing position. Thus, as shown in the environment 700, the features of static balance, the dynamic balance, and the gait associated with the user 504 may be captured, during the said movement, in each of the three phases. Based on the detection, a score is determined and stored in the fall predicting device 104 (or the fall predicting platform 406).

As mentioned above, the fall predicting device 104 may dynamically compare a current static attribute score with a predetermined static attribute score (i.e. threshold or historical) and compare a current dynamic attribute score with a predetermined dynamic attribute score (i.e. threshold or historical), to determine a first comparison value and a second comparison value, respectively. The historical scores may be stored as baseline capture 702 and current scores performed in real-time may be captured as monitoring capture 704. Therefore, a monitoring capture 704 may be compared with the baseline capture 702. Based on the comparison, the fall predicting device 104 may predict a possibility of an anticipated fall of the user. For example, a monitoring capture 704 being lower than the baseline capture 702 may indicate a decline in the well-being of the user that may lead to a possible fall in the future. In other words, when there is a decline in the quality of static and dynamic attributes (i.e. the static balance, dynamic balance, and gait) of the user, the possibility of fall occurring in the future increases.

Thus, the fall predicting device 104 may use the standard deviation and mean (e.g. associated with the gait and balance) of baseline data (baseline capture 702) as a reference to compare with real-time monitoring data (monitoring capture 704). The baseline scores represent the average performance of static and dynamic attributes over time, with deviations accounted for by the standard deviation. If the current scores in the monitoring capture 704 deviate significantly (fall below the baseline mean by more than an acceptable threshold), it indicates a decline in static balance, dynamic balance, or gait quality, which may suggest an increased likelihood of a future fall.

As shown in FIG. 8, in an environment 800, following the sitting-to-standing movement, the user 504 may start performing a walking movement that may be captured using the sensor 502. In particular, a time interval between transitioning from the sitting-to-standing to taking an initial walking step may be captured. Based on the signals from the sensor 502, the fall predicting device 104 may capture a point in time at which the sitting-to-standing movement is completed, and further capture a point in time at which the initial step for walking is taken by the user 504, to thereby determine the time interval. Further, based on the time interval, a score may be determined and may be stored in the fall predicting device 104 (or the fall predicting platform 406). Historical scores for this movement performed in the past may be stored as baseline capture 802 and a score for this activity performed in real-time (currently) may be captured as monitoring capture 804. The monitoring capture 804 may be compared with the baseline capture 802, and based on the comparison, the fall predicting device 104 may predict a possibility of an anticipated fall of the user. For example, a lower score (i.e. lower monitoring capture 804) may indicate a decline in the well-being of the user that may lead to a possible fall in the future. In other words, when the time taken to perform the activity of environment 800 increases as compared to the past, it may indicate a possible fall in the future.

As shown in FIG. 9, in an environment 900, following the movement of taking the initial walking step, the user 504 may start performing a subsequent movement of walking from a location-A to a location-B, that may be captured using the sensor 502. In particular, a time taken in relocating from the location-A to location-B may be captured. Based on the signals from the sensor 502, the fall predicting device 104 may capture a point in time at which this movement starts (i.e. at location-A), and further capture a point in time at which this movement is completed (at location-B). Further, based on the time taken, a score may be determined and may be stored in the fall predicting device 104 (or the fall predicting platform 406). Historical scores for this movement performed in the past may be stored as baseline capture 902 and a score for this movement performed in real-time (i.e. currently) may be captured as monitoring capture 904. The monitoring capture 904 may be compared with the baseline capture 902, and based on the comparison, the fall predicting device 104 may predict a possibility of an anticipated fall of the user. For example, a monitoring capture 904 lower than a baseline capture 902 may indicate a decline in the well-being of the user that may lead to a possible fall in the future. In other words, when the time taken to perform the said movement has become higher as compared to the past, it may indicate a possible fall in the future.

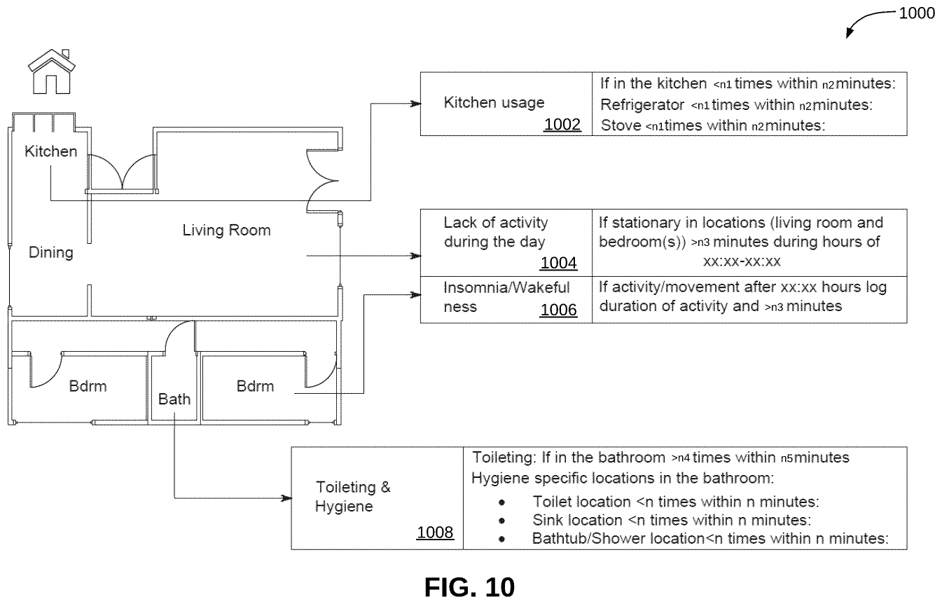

FIG. 10 is another schematic representation of the premises 402 and a process of monitoring various activities performed by a user within the premises 402, in accordance with some embodiments. A first activity 1002 may be associated with kitchen usage, and the sensor(s) 404 (not shown in FIG. 10) may obtain a plurality of signals associated with the user, capturing the performance of the first activity 1002. For example, the first activity 1002 may include a frequency of visiting the kitchen by user, or a frequency of accessing a refrigerator in the kitchen, or a frequency of accessing a stove in the kitchen. Based on the signals captured by the sensor(s), the above first activity may be detected, and a score may be determined. In particular, when a frequency of visiting the kitchen (e.g. n1 number of visits in n2 number of minutes) is higher than a predefined frequency, a higher score may be assigned, and vice versa. The fall predicting device 104 may dynamically compare an activity score for a real-time first activity 1002 with that of past first activities 1002 (performed at different timelines in the past), and based on the comparison, the fall predicting device 104 may predict a possibility of an anticipated fall of the user. For example, a score for real-time first activity 1002 lower than a score of the past first activities may indicate a decline in the well-being of the user that may lead to a possible fall in the future. Similarly, an analysis may be performed for the other examples of the first activity 1002, i.e. the frequency of accessing a refrigerator in the kitchen, and the frequency of accessing a stove in the kitchen, to predict a possible fall in the future.

A second activity 1004 may be associated with movement activities performed during the day by the user, and the sensor(s) 404 (not shown in FIG. 10) may obtain a plurality of signals associated with the user, capturing the performance of the second activity 1004. For example, the second activity 1004 may include time spent at one location, i.e. a bedroom or a living room within the premises 402. Based on the signals captured by the sensor(s), the above second activity may be detected, and a score may be determined. For example, when a time spent at one location is greater than a predetermined (i.e. threshold) number (i.e. n3 number of minutes) of minutes within a daytime range (i.e. between time t1 and time t2) is higher than a predefined time limit, a lower score may be assigned, and vice-versa. As will be understood, more time spent at one location may indicate a lack of activity and downfall in the well-being of the user. Further, the fall predicting device 104 may dynamically compare an activity score for a real-time second activity 1004 with that of past second activities, and based on the comparison, the fall predicting device 104 may predict a possibility of an anticipated fall of the user.

A third activity 1006 may be associated with sleep of the user, and the sensor(s) 404 (not shown in FIG. 10) may obtain a plurality of signals associated with the user, capturing the sleeping time period. The third activity 1006 may include time spent by the user sleeping within the premises 402. Based on the signals captured by the sensor(s), the above third activity may be detected, and a score may be determined. For example, a sleeping time duration lower than a predetermined (i.e. threshold) number of minutes (i.e. n4 number of minutes) may be indicative of a condition of insomnia, and hence in such cases, a lower activity score may be assigned. The fall predicting device 104 may dynamically compare an activity score for a real-time third activity 1006 with that of past third activities, and based on the comparison, may predict a possibility of an anticipated fall of the user.

A fourth activity 1008 may be associated with toilet or bathroom user, and the sensor(s) 404 (not shown in FIG. 10) may obtain a plurality of signals associated with the user. For example, the fourth activity may include a frequency of using a toilet, or a frequency of using a sink, or a frequency of using a bathtub/shower. Based on the signals captured by the sensor(s), the fourth activity may be detected, and a score may be determined. For example, when the frequency (i.e. using n4 times in n5 minutes) of using the toilet, or the sink, or the bathtub/shower is less than a predetermined (i.e. threshold) frequency, it may be indicative of a reduced activity of the user, and hence a lower activity score may be assigned. The fall predicting device 104 may dynamically compare an activity score for a real-time fourth activity 1008 with that of past fourth activities, and based on the comparison, may predict a possibility of an anticipated fall of the user.

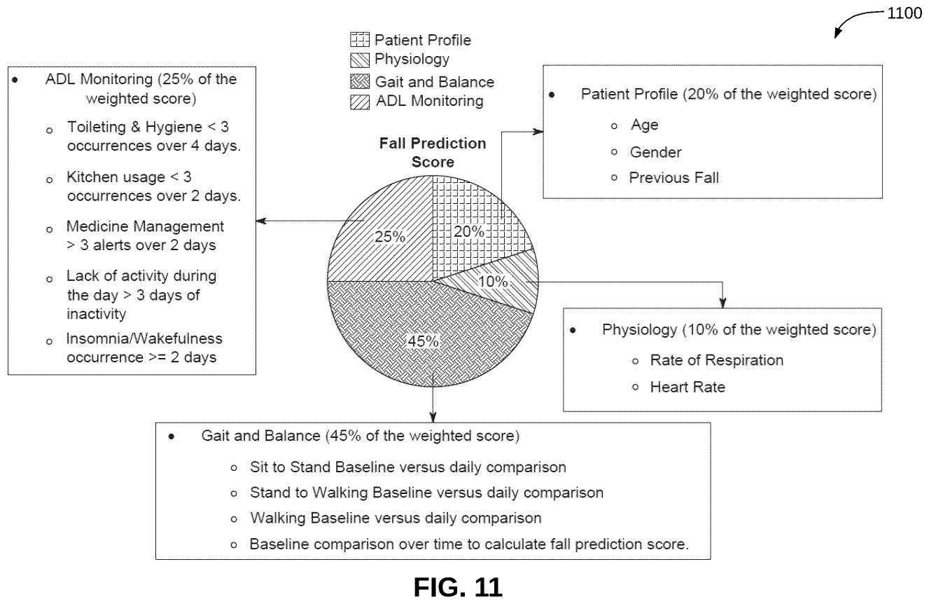

Referring now to FIG. 11, a graphical representation 1100 of weightages assigned to the various comparison scores related to corresponding features associated with the user is illustrated, in accordance with some embodiments. As mentioned above, a first weightage may be assigned to the first comparison value (which is related to the static attribute score) to calculate a weighted first comparison value; a second weightage may be assigned to the second comparison value (related to the dynamic attribute score) to calculate a weighted second comparison value; a third weightage may be assigned to the third comparison value (related to the activity score) to calculate a weighted first comparison value; a fourth weightage may be assigned to the fourth comparison value (related to the physiological feature score) to calculate a weighted fourth comparison value; and a fifth weightage may be assigned to the user profile data score to calculate a weighted user profile data score.

As will be understood, assigning weightage to comparison values associated with different features helps reflect relative importance of each feature in determining the (overall) fall score. As such, by assigning weightage, certain features can be prioritized over others based on their relevance or impact. For example, comparison values related to gait and balance may be assigned a higher weightage as compared to that of physiological features, if gait and balance are deemed relatively more critical to the assessment. By reflecting the true significance of each factor, weightage improves the accuracy of the fall score, ensuring it aligns more closely with real-world implications or desired outcomes.

As shown in FIG. 11, in some embodiments, a combined weightage assigned to the comparison values related to gait and balance may be 45%. In other words, the first comparison value and the second comparison value may be assigned a combined weightage of 45%. As such, a combination of the first weightage and the second weightage may be 45%. Therefore, comparison values associated with gait and balance during sit-to-stand, or stand to walking, or walking may be assigned 45%.

Further, as shown in FIG. 11, the third comparison value (related to the activity score) may be assigned the third weightage of 25%. Therefore, the third comparison value related to scores for activities bathroom or toilet visit, kitchen usage, medicine management, sleep, movement within the premises, and sleep may be assigned weightage of 25%. The fourth comparison value related to physiological feature score may be assigned the fourth weightage of 10%. In other words, the physiological features of heart rate and rate of respiration may be assigned fourth weightage of 10%. Furthermore, the user profile data score may be assigned the fifth weightage of 20%. As such, the features of age, gender, and previous fall data may be assigned the fifth weightage of 20%.

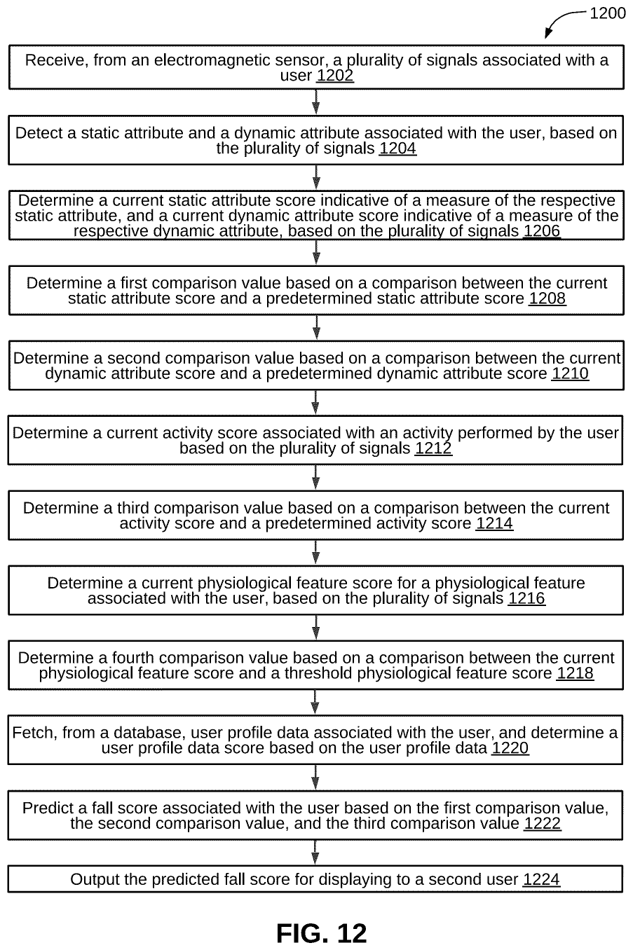

Referring now to FIG. 12, a flowchart of a method 1200 of predicting a fall of a user is illustrated, in accordance with some embodiments. The method 1200, for example, may be performed by the fall predicting device 104 or the fall predicting platform 406.

At step 1202, a plurality of signals associated with a user located within a premises may be received from an electromagnetic sensor (or simply, a sensor). The electromagnetic sensor, for example, may be an FMCW radar. The plurality of signals may be obtained over a predefined period of time.

At step 1204, a static attribute and a dynamic attribute associated with the user may be detected, based on the plurality of signals. By way of an example, the static attribute associated with the user may include a static balance associated with the user. The dynamic attribute may include a dynamic balance and/or a gait associated with the user.

At step 1206, a current static attribute score indicative of a measure of the respective static attribute, and a current dynamic attribute score indicative of a measure of the respective dynamic attribute may be determined, based on the plurality of signals.

At step 1208, a first comparison may be performed between a current static attribute score and a predetermined static attribute score to determine a first comparison value. The predetermined static attribute score may be a threshold static attribute score or a historical static attribute score. The historical static attribute score may be associated with a plurality of historical signals received over a past predefined period of time. In some embodiments, a first weightage may be assigned to the first comparison value to calculate a weighted first comparison value.

At step 1210, a second comparison may be performed between a current dynamic attribute score and a predetermined dynamic attribute score to determine a second comparison value. The predetermined dynamic attribute score may be a threshold dynamic attribute score or a historical dynamic attribute score. The historical dynamic attribute score may be associated with the plurality of historical signals received over the past predefined period of time. In some embodiments, a second weightage may be assigned to the second comparison value to calculate a weighted second comparison value.

At step 1212, a current activity score associated with an activity performed by the user may be determined based on the plurality of signals. The activity score may be indicative of at least one of: a time taken to perform the activity and a frequency of performing the activity. For example, the activity associated with the user may include bathroom or toilet visit, or kitchen usage, or medication management, or sleep, or movement within the premises.

At step 1214, a third comparison may be performed between a current activity score and a predetermined activity score, to determine a third comparison value. The predetermined activity score may be a threshold activity score or a historical activity score. The historical activity score may be associated with the plurality of historical signals associated with the activity. In some embodiments, a third weightage may be assigned to the third comparison value, to calculate a weighted third comparison value.

Additionally, in some embodiments, at step 1216, a current physiological feature score may be determined for a physiological feature associated with the user, based on the plurality of signals. The physiological feature associated with the user may be one of: a rate of respiration and a heart rate.

At step 1218, a fourth comparison may be performed between the current physiological feature score and a predetermined physiological feature score, to determine a fourth comparison value. In some embodiments, the predetermined physiological feature score may be a threshold physiological feature score or a historical physiological feature score. In some embodiments, a fourth weightage may be assigned to the fourth comparison value to calculate a weighted fourth comparison value.

In some embodiments, additionally, at step 1220, user profile data associated with the user may be fetched from a database, and a user profile data score may be determined. For example, the user profile data associated with the user may include at least one of: age, gender, and historical fall data associated with the user. In some embodiments, a fifth weightage may be assigned to the user profile data score to calculate a weighted user profile data score.

At step 1222, the fall score may be predicted based on at least one of: the first comparison value, the second comparison value, the third comparison value, the fourth comparison value, and the user profile data score. In some embodiments, where weightages are considered, the fall score may be predicted based on at least one of: the weighted first comparison value, the weighted second comparison value, the weighted third comparison value, the weighted fourth comparison value, and the weighted user profile data score.

At step 1224, the predicted fall score may be outputted for displaying to a second user. For example, a notification may be generated and displayed to a second user (e.g. a caretaker, a hospital staff member, a family member, etc.) via a display screen (e.g. of a smartphone).

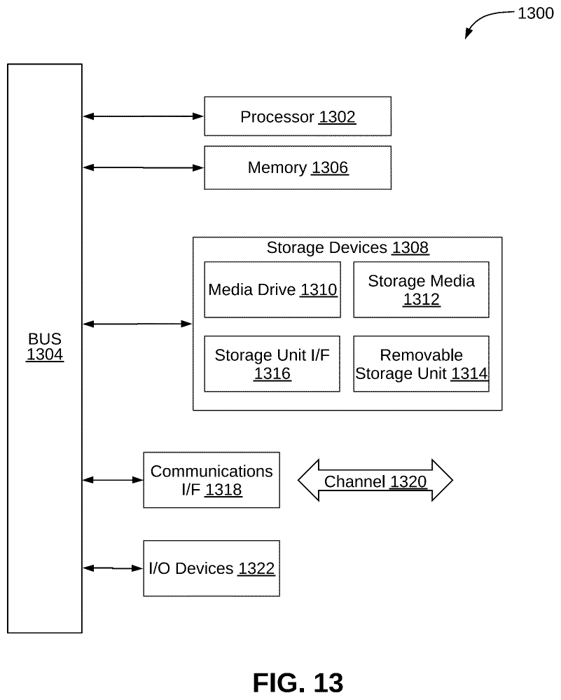

Referring now to FIG. 13, an exemplary computing system 1300 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 1300 may represent, for example, a user device such as a desktop, a laptop, a mobile phone, personal entertainment device, DVR, and so on, or any other type of special or general-purpose computing device as may be desirable or appropriate for a given application or environment. The computing system 1300 may include one or more processors, such as a processor 1302 that may be implemented using a general or special purpose processing engine such as, for example, a microprocessor, microcontroller or other control logic. In this example, the processor 1302 is connected to a bus 1304 or other communication media. In some embodiments, the processor 1302 may be an Artificial Intelligence (AI) processor, which may be implemented as a Tensor Processing Unit (TPU), or a graphical processor unit, or a custom programmable solution Field-Programmable Gate Array (FPGA).

The computing system 1300 may also include a memory 1306 (main memory), for example, Random Access Memory (RAM) or other dynamic memory, for storing information and instructions to be executed by the processor 1302. The memory 1306 also may be used for storing temporary variables or other intermediate information during the execution of instructions to be executed by processor 1302. The computing system 1300 may likewise include a read-only memory (“ROM”) or other static storage device coupled to bus 1304 for storing static information and instructions for the processor 1302.

The computing system 1300 may also include storage devices 1308, which may include, for example, a media drive 1310 and a removable storage interface. The media drive 1310 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 1312 may include, for example, a hard disk, magnetic tape, flash drive, or other fixed or removable media that is read by and written to by the media drive 1310. As these examples illustrate, the storage media 1312 may include a computer-readable storage medium having stored therein particular computer software or data.

In alternative embodiments, the storage devices 1308 may include other similar instrumentalities for allowing computer programs or other instructions or data to be loaded into the computing system 1300. Such instrumentalities may include, for example, a removable storage unit 1314 and a storage unit interface 1316, such as a program cartridge and cartridge interface, a removable memory (for example, a flash memory or other removable memory module) and memory slot, and other removable storage units and interfaces that allow software and data to be transferred from the removable storage unit 1314 to the computing system 1300.

The computing system 1300 may also include a communications interface 1318. The communications interface 1318 may be used to allow software and data to be transferred between the computing system 1300 and external devices. Examples of the communications interface 1318 may include a network interface (such as an Ethernet or other NIC card), a communications port (such as for example, a USB port, a micro-USB port), Near field Communication (NFC), etc. Software and data transferred via the communications interface 1318 are in the form of signals which may be electronic, electromagnetic, optical, or other signals capable of being received by the communications interface 1318. These signals are provided to the communications interface 1318 via a channel 1320. The channel 1320 may carry signals and may be implemented using a wireless medium, wire or cable, fiber optics, or other communications medium. Some examples of the channel 1320 may include a phone line, a cellular phone link, an RF link, a Bluetooth link, a network interface, a local or wide area network, and other communications channels.

The computing system 1300 may further include Input/Output (I/O) devices 1322. Examples may include, but are not limited to a display, keypad, microphone, audio speakers, vibrating motor, LED lights, etc. The I/O devices 1322 may receive input from a user and also display an output of the computation performed by the processor 1302. In this document, the terms “computer program product” and “computer-readable medium” may be used generally to refer to media such as, for example, the memory 1306, the storage devices 1308, the removable storage unit 1314, or signal(s) on the channel 1320. These and other forms of computer-readable media may be involved in providing one or more sequences of one or more instructions to the processor 1302 for execution. Such instructions, generally referred to as “computer program code” (which may be grouped in the form of computer programs or other groupings), when executed, enable the computing system 1300 to perform features or functions of embodiments of the present invention.

In an embodiment where the elements are implemented using software, the software may be stored in a computer-readable medium and loaded into the computing system 1300 using, for example, the removable storage unit 1314, the media drive 1310 or the communications interface 1318. The control logic (in this example, software instructions or computer program code), when executed by the processor 1302, causes the processor 1302 to perform the functions of the invention as described herein.

One or more techniques for generating recommendations for enhancement of an existing legacy or monolith application are disclosed. The techniques provide for a solution for visualizing different datatypes, irrespective of each datatype having their respective representation. As such, the techniques allow developers to visualize geometric entities while debugging to thereby aid in code understanding and maintenance. Further, the techniques are not limited by the IDE extendibility or the programming language. Furthermore, the above techniques provide a two-way communication channel that allows the debugger to post queries and receive corresponding rendering. The techniques are independent of different IDEs and platforms. The techniques help in reducing overall application (code) development time and effort.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method for predicting a fall of a user, the method comprising:
receiving, from an electromagnetic sensor, a plurality of signals associated with a user, wherein the plurality of signals is received over a predefined period of time;
detecting a static attribute and a dynamic attribute associated with the user, based on the plurality of signals, wherein the static attribute is associated with a static balance of the user, and wherein the dynamic attribute is associated with one of: a dynamic balance, or a gait of the user;
determining a current static attribute score indicative of a measure of the respective static attribute, and a current dynamic attribute score indicative of a measure of the respective dynamic attribute, based on the plurality of signals;
determining a first comparison value based on a comparison between the current static attribute score and a predetermined static attribute score;
determining a second comparison value based on a comparison between the current dynamic attribute score and a predetermined dynamic attribute score;
determining a current activity score associated with an activity performed by the user based on the plurality of signals, wherein the activity score is indicative of at least one of: a time taken to perform the activity and a frequency of performing the activity;
determining a third comparison value based on a comparison between the current activity score and a predetermined activity score;
predicting a fall score associated with the user based on the first comparison value, the second comparison value, and the third comparison value, wherein the fall score is indicative of an anticipated fall of the user; and
outputting the predicted fall score for displaying to a second user.

2. The method of claim 1, wherein
the predetermined static attribute score is one of: a threshold static attribute score and a historical static attribute score, wherein the historical static attribute score is associated with a plurality of historical signals received over a past predefined period of time,
the predetermined dynamic attribute score is one of: a threshold dynamic attribute score and a historical dynamic attribute score, wherein the historical dynamic attribute score is associated with the plurality of historical signals received over the past predefined period of time, and
the predetermined activity score is one of: a threshold activity score and a historical activity score, wherein the historical activity score is associated with the plurality of historical signals associated with the activity.

3. The method of claim 1, wherein the activity associated with the user comprises at least one of: bathroom or toilet visit, kitchen usage, medicine management, sleep, and movement within the premises.

4. The method of claim 1, further comprising:
assigning a first weightage to the first comparison value to calculate a weighted first comparison value;
assigning a second weightage to the second comparison value to calculate a weighted second comparison value; and
assigning a third weightage to the third comparison value to calculate a weighted third comparison value,
wherein the fall score associated with the user is predicted based on the weighted first comparison value, the weighted second comparison value, and the weighted third comparison value.

5. The method of claim 1, wherein predicting the fall score further comprises:
determining a current physiological feature score for a physiological feature associated with the user, based on the plurality of signals, wherein the physiological feature associated with the user is one of: a rate of respiration and a heart rate;
determining a fourth comparison value based on a comparison between the current physiological feature score and a predetermined physiological feature score; and
predicting the fall score based on the first comparison value, the second comparison value, the third comparison value, and the fourth comparison value.

6. The method of claim 5,
wherein the predetermined physiological feature score is one of a threshold physiological feature score and a historical physiological feature score.

7. The method of claim 5, further comprising:
assigning a fourth weightage to the fourth comparison value to calculate a weighted fourth comparison value,
wherein the fall score associated with the user is predicted based on the weighted first comparison value, the weighted second comparison value, the weighted third comparison value, and the weighted fourth comparison value.

8. The method of claim 1, predicting the fall score further comprises:
fetching, from a database, user profile data associated with the user, wherein the user profile data comprises at least one of: age, gender, and historical fall data associated with the user;
determining a user profile data score based on the user profile data; and
predicting the fall score based on the first comparison value, the second comparison value, the third comparison value, and the user profile data score.

9. The method of claim 8, further comprising assigning a fifth weightage to the user profile data score to calculate a weighted user profile data score,
wherein the fall score associated with the user is predicted based on the weighted first comparison value, the weighted second comparison value, the weighted third comparison value, and the weighted user profile data score.

10. The method of claim 1, wherein predicting the fall score further comprises:
feeding the first comparison value, the second comparison value, and the third comparison value to a pre-trained Machine Learning (ML) model; and
receiving, from the ML model, the fall score indicative of the anticipated fall of the user.

11. The method of claim 1, further comprising:
generating a notification based on the fall score for alerting the second user, when the fall score is above a threshold fall score.

12. A system comprising:
a memory configured to store computer-executable instructions; and
one or more processors configured to execute the computer-executable instructions to:
receive, from an electromagnetic sensor, a plurality of signals associated with a user, wherein the plurality of signals is received over a predefined period of time;
detect a static attribute and a dynamic attribute associated with the user, based on the plurality of signals, wherein the static attribute is associated with a static balance of the user, and wherein the dynamic attribute is associated with one of: a dynamic balance, or a gait of the user;
determine a current static attribute score indicative of a measure of the respective static attribute, and a current dynamic attribute score indicative of a measure of the respective dynamic attribute, based on the plurality of signals;
determine a first comparison value based on a comparison between the current static attribute score and a predetermined static attribute score;
determine a second comparison value based on a comparison between the current dynamic attribute score and a predetermined dynamic attribute score;
determine a current activity score associated with an activity performed by the user based on the plurality of signals, wherein the activity score is indicative of at least one of:
a time taken to perform the activity and a frequency of performing the activity;
determine a third comparison value based on a comparison between the current activity score and a predetermined activity score;
predict a fall score associated with the user based on the first comparison value, the second comparison value, and the third comparison value, wherein the fall score is indicative of an anticipated fall of the user; and
output the predicted fall score for displaying to a second user.

13. The system of claim 12, wherein
the predetermined static attribute score is one of: a threshold static attribute score and a historical static attribute score, wherein the historical static attribute score is associated with a plurality of historical signals received over a past predefined period of time,
the predetermined dynamic attribute score is one of: a threshold dynamic attribute score and a historical dynamic attribute score, wherein the historical dynamic attribute score is associated with the plurality of historical signals received over the past predefined period of time, and
the predetermined activity score is one of: a threshold activity score and a historical activity score, wherein the historical activity score is associated with the plurality of historical signals associated with the activity.

14. The system of claim 12, wherein the one or more processors are further configured to:
assign a first weightage to the first comparison value to calculate a weighted first comparison value;
assign a second weightage to the second comparison value to calculate a weighted second comparison value; and
assign a third weightage to the third comparison value to calculate a weighted third comparison value,
wherein the fall score associated with the user is predicted based on the weighted first comparison value, the weighted second comparison value, and the weighted third comparison value.

15. The system of claim 12, wherein to predict the fall score the one or more processors are further configured to:
determine a current physiological feature score for a physiological feature associated with the user, based on the plurality of signals, wherein the physiological feature associated with the user is one of: a rate of respiration and a heart rate;
determine a fourth comparison value based on a comparison between the current physiological feature score and a predetermined physiological feature score; and
predict the fall score based on the first comparison value, the second comparison value, the third comparison value, and the fourth comparison value.

16. The system of claim 12, wherein the one or more processors are further configured to:
assign a fourth weightage to the fourth comparison value to calculate a weighted fourth comparison value,
wherein the fall score associated with the user is predicted based on the weighted first comparison value, the weighted second comparison value, the weighted third comparison value, and the weighted fourth comparison value.

17. The system of claim 12, wherein to predict the fall score the one or more processors are further configured to:
fetch, from a database, user profile data associated with the user, wherein the user profile data comprises at least one of: age, gender, and historical fall data associated with the user;
determine a user profile data score based on the user profile data; and
predict the fall score based on the first comparison value, the second comparison value, the third comparison value, and the user profile data score.

18. The system of claim 12, wherein the one or more processors are further configured to assign a fifth weightage to the user profile data score to calculate a weighted user profile data score,
wherein the fall score associated with the user is predicted based on the weighted first comparison value, the weighted second comparison value, the weighted third comparison value, and the weighted user profile data score.

19. The system of claim 12, wherein to predict the fall score the one or more processors are further configured to:
feed the first comparison value, the second comparison value, and the third comparison value to a pre-trained Machine Learning (ML) model; and
receive, from the ML model, the fall score indicative of the anticipated fall of the user.

20. A computer programmable product comprising a non-transitory computer-readable medium having stored thereon computer-executable instructions, which when executed by one or more processors, cause the one or more processors to carry out operations for predicting fall of a user, the operations comprising:
receiving, from an electromagnetic sensor, a plurality of signals associated with a user, wherein the plurality of signals is received over a predefined period of time;
detecting a static attribute and a dynamic attribute associated with the user, based on the plurality of signals, wherein the static attribute is associated with a static balance of the user, and wherein the dynamic attribute is associated with one of: a dynamic balance, or a gait of the user;
determining a current static attribute score indicative of a measure of the respective static attribute, and a current dynamic attribute score indicative of a measure of the respective dynamic attribute, based on the plurality of signals;
determining a first comparison value based on a comparison between the current static attribute score and a predetermined static attribute score;
determining a second comparison value based on a comparison between the current dynamic attribute score and a predetermined dynamic attribute score;
determining a current activity score associated with an activity performed by the user based on the plurality of signals, wherein the activity score is indicative of at least one of: a time taken to perform the activity and a frequency of performing the activity;
determining a third comparison value based on a comparison between the current activity score and a predetermined activity score;
predicting a fall score associated with the user based on the first comparison value, the second comparison value, and the third comparison value, wherein the fall score is indicative of an anticipated fall of the user; and
outputting the predicted fall score for displaying to a second user.
